(19) United States
(12) Patent Application Publication
(10) Pub. No.: US 2008/0151363 A1
(43) Pub. Date: Jun. 26, 2008

(54) Arrangement in an Imaging System for Microtitre Wells

(75) Inventors: Vesa Erkkila, Mietoinen (FI); Ari Kuusisto, Turku (FI)

Correspondence Address: BUCHANAN, INGERSOLL & ROONEY PC, POST OFFICE BOX 1404, ALEXANDRIA, VA, 22313-1404, US

(73) Assignee: Wallac Oy, Turku (FI)

(21) Appl. No.: 11/883,337

(22) PCT Filed: Jan. 27, 2006
(86) PCT No.: PCT/FI2006/050044

§ 371 Date: Jul. 30, 2007

(30) Foreign Application Priority Data
Jan. 31, 2005 (FI) 20055043

(51) Int. Cl. G02B 13/22

(52) U.S. Cl. 359/363

(57) ABSTRACT

The disclosure relates to an arrangement in an imaging system for microtitre wells, the arrangement comprising a sample plate having a plurality of wells for samples, and a lens system arranged in connection with the sample plate and comprising an objective and at least one lens group for imaging the rays representing the structure of the samples and passing through the objective to an image detector. In order for the arrangement to enable a rapid imaging of the samples in the wells with a high resolving power, the lens system comprises a plurality of objectives focused to infinity for collecting rays representing the samples, the objectives being at least partly arranged detachably inside wells in the sample plate. The disclosure also relates to a method of imaging samples in microtitre wells.

### BACKGROUND OF THE INVENTION

The invention relates to the imaging of microtitre wells. More specifically, the invention relates to an arrangement in an imaging system for samples placed in microtitre wells, the arrangement comprising a sample plate having a plurality of wells for samples, and a lens system arranged in connection with the sample plate and comprising an objective and at least one lens group for forming an image of the structure of a sample from light rays representing the sample and passing through the objective onto an image detector.

The invention also relates to a method of imaging samples placed in microtitre wells with an arrangement comprising a sample plate having a plurality of wells for samples, and a lens system arranged in connection with the sample plate and comprising an objective and at least one lens group for forming an image of the structure of a sample from light rays representing the sample and passing through the objective onto an image detector.

It is known to process and/or store samples collected, particularly microbiological samples, in a sample plate comprising a plurality of vessels in the shape of small holes. At times, these sample plates are called microtitre plates and the vessels therein wells or microtitre wells. The number of wells is e.g. 96 (12×8), hut may be significantly higher, e.g. 384, 1,536 or even higher.

The samples to be placed in the wells are either in liquid form or in solid form. The present invention relates particularly, although not exclusively, to samples in solid form and the imaging thereof. In the arrangement according to the invention, the well is typically dry at the time of the assay/imaging. A sample in liquid form can be dried before imaging. An example of a dry sample is a cell collected onto a filter. Another example is a spot-like sample (‘spot’), which is used to determine the content of a substance.

When said samples are to be analyzed, a lens system is placed in connection with the wells, through which lens system a light beam from the sample being assayed is directed to an image detector, typically a camera, allowing an image of the sample being assayed to be obtained with the camera.

US 2002/0034027 A1 discloses an arrangement and method of the aforementioned type for imaging samples in wells of microtitre wells. The arrangement comprises an immersion lens arranged immediately above the sample plate, the lens collecting rays representing the samples, and a collimation lens separate from the immersion lens and imaging the structure of the samples with the image detector. To obtain a sharp image of the structure of the sample, the collimation lens-image detector assembly has to be accurately positioned in respect of the immersion lens.

In sample imaging, good resolving power and efficient light collection are desirable. The resolving power, or resolution, is proportional to the numerical aperture of the lens system. The numerical aperture, in turn, is determined by the ratio of the diameter of the front lens of the lens system to the distance of the object/sample assayed. As a result, the aim is on the one hand to use a front lens having a diameter as large as possible and on the other hand the aim is to place the lens system close to the sample to be observed/imaged.

In some applications, the diameter of the wells may be relatively large (several dozens of millimetres) and their height may be small, whereby a high resolving power can be easily achieved by the use of a front lens having a large diameter. However, in many assays, the use of wide and shallow wells is out of the question. For example, in liquid samples wherein evaporation of the liquid should be prevented, wide wells are out of the question. Similarly, when the cells or other samples are to concentrate within a small area, wells having a large diameter cannot be used. In the latter cases, a narrow and deep well should be employed, whereby relatively much sample liquid is present compared with the area of the bottom of the well.

Increasing the diameter of the front lens of the lens system in the latter assays does not result in a higher resolving power, or in a good light collection efficiency and the desired result, since the well edges limit the usable diameter of the front lens when the front lens is close to the sample. The minimum distance of the front lens from the sample is determined by the height of the well. Placing the front lens farther away from the sample enables the utilization of the size of a large front lens in practice as regards resolving power, but in such an arrangement, the resolving power is on the other hand impaired by the increased distance from the sample. Accordingly, a larger diameter in the front lens does not achieve the desired result. Since the distance of the lens system from the sample highly affects the quality of the image and the quality of the assay, the lens system and/or sample has to be displaced and extremely accurately adjusted separately for each well.

In an effort to improve the resolving power, it is known to arrange the lens system under the microtitre wells. This allows the lens system to be arranged quite close to the sample, which improves the resolving power and the light collection efficiency. However, a drawback in such an arrangement is that the bottom material of the well more or less impedes the assay by causing distortions. The latter drawback can be reduced by making the well bottoms as even as possible and from a material that does not tend to be distorted; the bottoms shall preferably also be thin. The manufacture of such wells is expensive. In addition, exactly as in the case wherein the lens system is above the wells, a lens system and/or sample arranged below the wells has to be displaced and adjusted at each well separately, which is laborious and slow.

Publications GB 2351556 B and U.S. Pat. No. 6,519,032 B1 disclose arrangements for measuring the intensity differences of samples in microtitre wells.

Publication U.S. Pat. No. 5,736,410 discloses an arrangement for measuring the emission of samples on a sample plate.

### BRIEF DESCRIPTION OF THE INVENTION

The object of the invention is to achieve an arrangement and a method for eliminating said drawbacks and particularly for achieving an increased resolving power and increased light collection efficiency in a microtitre well imaging system, whereby an accurate image is obtained from the samples in the microtitre wells.

For achieving the objects, the arrangement according to the invention is characterized in that that the lens system comprises a plurality of such objectives, the objectives being at least partly and detachably arranged inside wells in the sample plate, each objective being focused to infinity and arranged to collect the light rays representing a sample at the focal plane of the objective, and said light rays being arranged to pass through a lens group for forming an image of the structure of the sample onto the image detector.

The optical element is typically a lens, but it may be for instance a so-called diffractive element based on light diffraction (rastered surface).

The diameter of the object should be significantly smaller than is known in microtitre well imaging systems; the diameter may be e.g. 3 to 5 mm. The number of optical element comprised by the objective, e.g. lenses, may vary.

The expression ‘objective focused to infinity and at least partly arranged inside a well’ means that the rays representing a given sample point advance as a collimated beam from the objective that is at least partly arranged inside the well. In the present invention, a bundle of the collimated beams representing the different points of the sample advances from the objective towards the lens group belonging to the imaging system. Owing to this, the distance of the lens group from the objective is not critical for obtaining an accurate image in the image detector (camera). The latter significantly facilitates the placement of the lens group and the camera relative to the objective and the sample, which enables very rapid imaging. Since the lens group and the camera are expensive components compared with an objective installed inside a well, the procedure in accordance with the invention is to place a plurality of objectives focused to infinity detachably at least partly inside the wells of a sample plate; to adapt the lens group at a distance from the objective belonging to the lens system, separately from the objective and on the same side of the well bottom as the objective; to illuminate the sample in the well; to collect the rays representing the sample by means of the objective; and to form an image of the sample from the light rays describing the structure of the sample and passing through the objective, by means of the lens group to the image detector.

According to a preferred embodiment of the invention, the lens group and the camera are displaced relative to the objectives and the samples (or the objectives and samples are displaced relative to the lens group/camera combination) in such a manner that one or a few lens group/camera combinations (lens group/camera assembly) images all samples in the microtitre wells. Displacement devices are arranged to displace the lens group/camera combination at least laterally (on the horizontal plane). Each well does not have to be provided with an objective, instead, an objective array can be built and displaced from one well array of the microtitre plate to another a sufficient number of times in order to enable the processing of all wells to be assayed. In accordance therewith, by displacing for instance two objective arrays composed of four objectives 12 times, all wells of a microtitre plate comprising 96 wells can be analysed. To achieve a very rapid assay, the objective array comprises as many objectives as there are wells in the microtitre plate, whereby it is sufficient to install/focus the objective array in place once before the measurement of the entire sample plate is initiated, after which the lens group/camera combination is displaced from one place to another as many times as is necessary for assaying all wells. In the latter case, if there are four lens group/camera combinations, the latter are displaced 24 times, after which all samples in the microtitre plate have been imaged. The objective array is preferably attached to a common holder. This being so, the simultaneous displacement of a plurality of objectives is possible with displacement means whose structure is such that they are capable of displacing objectives both vertically and laterally. It is feasible that the size of the image detector is selected so large that its field of view covers more than one objective and lens group in such a manner that it covers the light beams from four objectives and a lens group, for instance, whereby the image detector is capable of imaging four samples at a time. The latter arrangement is to be preferred if an expensive camera is employed as the image detector. This being so, the image detector is not displaced, instead, only the lens group is displaced.

The optical element inside the well can be preferably a gradient index lens, a so-called GRIN lens. Such a lens has a gradient profile that refracts light and that can be freely designed and no disturbing spherical distortion, for example, is generated. The gradient Index lens, which is in the shape of a small glass rod, is also inexpensive to manufacture in large amounts. A diffractive element may be arranged on the surface of the gradient index lens.

The element to be adapted inside the well may be a diffractive element in the shape of a thin glass plate. The advantages of a diffractive lens are that it is very small, it is inexpensive to manufacture in large amounts by utilizing the replication technique, it may be used to correct spherical or chromatic aberrations and it can be used to implement many things that cannot be achieved with usual lenses (for example, a beam of light can be split into a plurality of similar beams, diversiform focus points can be achieved, etc.).

Preferred embodiments of the arrangement according to the invention are presented in the attached claims 2 to 19.

For achievement of the objects of the invention, the method of the invention is mainly characterized by
arranging a plurality of such objectives at least partly and detachably inside wells of the sample plate, the objectives belonging to said lens system and being focused to infinity,
arranging the lens group at a distance from an objective of said plurality of objectives separately from the objective and on the same side of a well bottom as the objective,
illuminating a sample in the well,
collecting light rays representing the sample by means of the objective,
and forming an image of the sample from the light rays onto the image detector with the lens group.

In the method of the invention, the lens group and the image detector are preferably constructed as a lens group/image detector assembly, whereby this lens group/image detector assembly is repeatedly displaced relative to a combination of sample plate/objectives and images are formed of all samples in the wells.

The main advantages of the arrangement and method of the invention are the ability to image the structure of samples in microtitre wells with high resolving power and very rapidly. The sample plates and microtitre wells can be manufactured without expensive special techniques and materials, since no beams of light are directed to the lens arrangement arranged above the well bottoms through the well bottoms.

### BRIEF DESCRIPTION OF THE FIGURES

In the following, the invention will be described in more detail in connection with five preferred embodiments with reference to the accompanying drawings, in which

FIG. 1 is an illustrative side view of a first embodiment of the arrangement according to the invention,

FIG. 2 is an axonometric view of a second embodiment of the arrangement according to the invention,

FIG. 3 an axonometric view of a third embodiment of the arrangement according to the invention,

FIG. 4 is a top view of the embodiment of FIG. 3,

FIG. 5 shows a fourth embodiment of the arrangement according to the invention, and

FIG. 6 shows a fifth embodiment of the arrangement according to the invention.

### DETAILED DESCRIPTION OF THE INVENTION

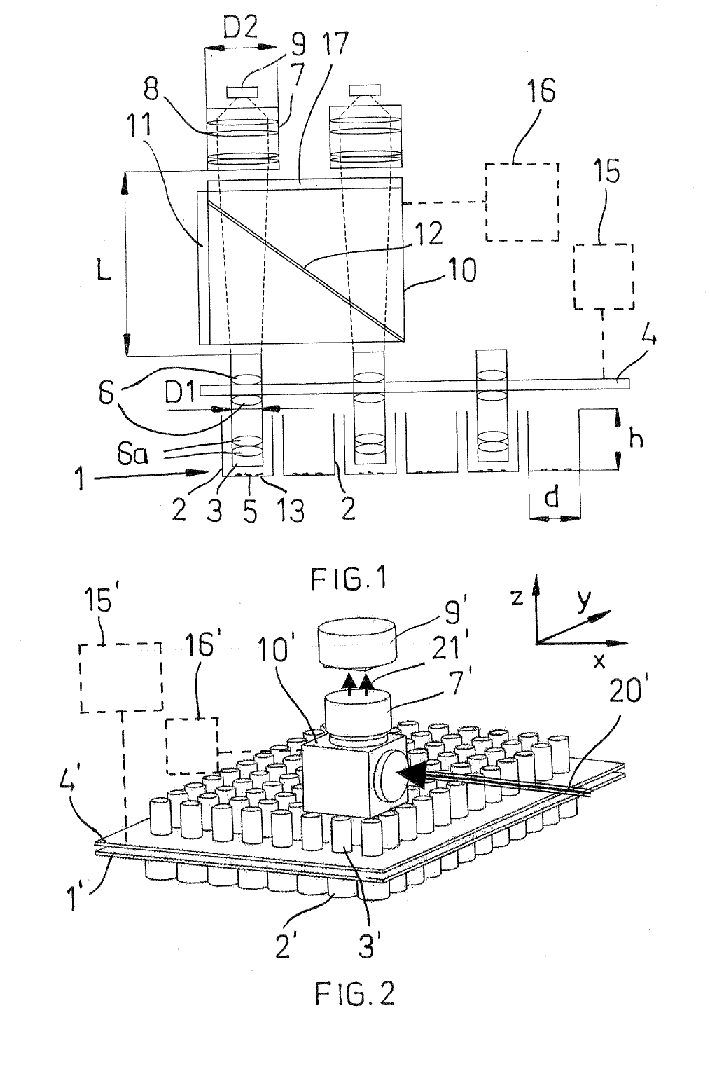

The arrangement shown in FIG. 1 comprises a disposable sample plate, generally denoted by reference numeral 1, comprising a plurality of wells 2 for samples 5. The figure only shows six wells 2, although there are typically several dozens of them, e.g. 96, as is shown in the embodiment of FIG. 2. The sample plate 2 may be called a microtitre plate, which describes the small size thereof and the wells therein. The diameter d of the wells 2 is typically about 6 mm and the height h of the wells is 8 mm, for example. The diagonal and height of the wells 2 in the microtitre plate may vary depending for instance on the size of the microtitre plate and the number and shape of wells. The diagonal of the wells in the microtitre plate is preferably within the range 3 to 7 mm. The wells 2 are typically cylindrical, their diameter being at most 10 mm. At times, the sample plates are called microplates or titre plates.

In the arrangement of FIG. 1, an objective 3 is placed inside every second well 2. More exactly expressed, the objectives 3 are located only partly in the well 2, since the upper part of the objectives is above the well. The diameter D1 of the objective 3 is about 4 mm. The diameter D1 may vary depending on the application; it is to be expected that the most preferred diameter range is 3 to 5 mm, but the ranges 0.5 to 7 mm, 2 to 10 mm and 0.5 to 10 mm are also feasible. If the diameter D1 is much below 1 mm, e.g. below 0.1 mm, the lens must be brought very close to the bottom 13 of the well 2 in order to achieve a good resolving power, which is cumbersome. In this case, the area seen by the lens is also very small and, in addition, the manufacture of such a lens is cumbersome and expensive. There is also the risk that the objective 3 can touch the sample when being inserted into the well 2. If the diameter D1 exceeds 20 mm, the objective 3 cannot at all be inserted into the well 2 unless the diameter of the lower part of the objective 3 is sufficiently small, e.g. less than 10 mm or less than 7 mm, depending on the diameter of the well. The number of lenses 6, 6a in the objective 3 may vary. In some cases, one lens may be sufficient; the objective 3 of the figure comprises four lenses. In the case of FIG. 1, two lenses 6a out of the four lenses of the objective 3 are arranged inside the well 2. The distance of the lowermost lens 6 of the objective 3 from the sample 5 to be assayed is only few millimetres, typically only about 2 mm, i.e. significantly smaller than the height h of the well.

Because the objective 3 is inserted into the well 2, i.e. close to the sample 5 at the bottom 13 of the well, the resolving power and light collection efficiency become high.

The objective 3 is focused to infinity. The beam (i.e. the bundle of collimated beams) of light representing the sample is illustrated with two broken lines, drawn from the upper end of the objective 3 towards the lens group 7. The angle of divergence of the light beam of the lens group 7 depends on the size of the field of view and focal distance of the objective, and is typically only few degrees. The lens group 7 is separate from the objective 3. Because the objective 3 is focused to infinity, the distance L of the lens group 7 from the objective 3 is not critical for obtaining an accurate image from the sample 5 to a camera 9 or other image detector above the lens group. The placement of the lens group/camera combination 7, 9 at an exactly given distance from the objective 3 and the sample 5 is thus not necessary, owing to which a coarse and sufficient focusing in the vertical direction (the so-called z direction) can be performed with simple and inexpensive displacement devices. In FIGS. 1 to 3, said displacement devices are drawn schematically with a broken line and denoted by reference numerals 16, 16′ and 16″. The lens group/camera combination 7, 9 is formed as a unit or assembly. The diameter D2 of the lenses 8 in the lens group 7 is substantially larger than the light beam, representative of the sample, emitted from the objective 3 and hitting the lens group, whereby the focusing of the assembly formed by the lens group/camera combination 7, 9 on the x-y plane (laterally, i.e. in the x and/or y direction), cf. FIG. 2, does not either require great accuracy. In the arrangement of FIG. 1, the large diameter D2 of the lenses 8 in the lens group 7 can be fully utilized in this sense. The diameter D2 is typically larger than 20 mm (e.g. 30 to 50 mm), but may in some cases be within the range 10 to 20 mm. The number of lenses 8 in the lens group 7 may vary. By changing the focal length of the lens group 7, the magnification can also be changed.

A filter assembly 10 is disposed between the lens group 7 and the objective 3. The filter assembly 10 comprises a filter 11 for excitation light, a filter 17 for light emitted from the sample, and a beam splitter 12, which is a sort of a mirror that splits the light beam emitted through the objective into two parts. The splitting of the light beam may be based on the wavelength, polarization or other property of the light or then the light beam is simply split as such into two light beams. The filter assembly 10 is not obligatory, but useful in use when the fluorescence is to be excited, for example.

The filter assembly 10 is arranged to be displaced along with the displacement of the lens group 7. Consequently, the same displacement devices 16, which are arranged to displace the lens group and the camera 9, also preferably displace the filter assembly 10.

It might be feasible that the size of the camera 9 or the image detector is large to possess such a large ‘imaging area’ that they cover a plurality of lens groups. In this case, a displacement arrangement (not shown) is employed, which is arranged to displace the lens groups 7 relative to the camera 9 or the image detector.

The objectives 3 are fastened to a holder 4, which enables the simultaneous coordinated displacement of the objectives 3 by the displacement means 15 relative to the sample plate 1. In FIGS. 1, 2 and 3, the displacement means are schematically shown with a broken line and denoted with reference numerals 15, 15′ and 15″. Consequently, by lifting the holder 4 with the displacement means 15 (in the so-called z direction, cf. FIG. 2), all objectives 3 rise upwards, and by displacing (with the displacement means 15) the holder in a planar manner laterally, all objectives 3 are displaced in a planar manner laterally. Said arrangement enables the analysis of all wells 2, i.e. the imaging of the samples 5 in the wells, with a number of objectives that is below the number of wells. Naturally, it is possible to place a separate objective in each well, which naturally increases the number of objectives required. However, an increase in the number of objectives 3 is not an extremely expensive solution, and therefore an arrangement comprising an objective 3 in all wells 2 is preferable in some assays. The acquisition costs of the objectives 3 are relatively low compared with the acquisition costs of the lens group/camera unit 7, 9.

In the arrangement of FIG. 1, the objectives 3 are installed with the displacement means 15 inside every second well 2 accurately in the right point relative to the samples 5 to be imaged, after which the samples 5 are imaged with two cameras 9, each having a lens group but sharing a common filter assembly 10. The cameras 9 are displaced with the displacement devices 16 on top of the wells 2 to be imaged so many times that all samples are imaged. Since every second well contains an objective 3, the samples above which is an objective are imaged first with the cameras, after which the objectives 3 are displaced to the adjacent wells, and the samples above which there is an objective are imaged, until all samples in the wells are imaged. After this, the sample plate may be discarded.

FIG. 2 shows a second embodiment of the arrangement according to the invention. In FIG. 2, the same reference numbers are used as in FIG. 1 for corresponding components.

The arrangement of FIG. 2 differs from the embodiment of FIG. 1 in that a separate objective 3′ is installed in each well 2′, and only one lens group/camera combination 7′, 9′ is arranged to image the samples in the wells. The objectives 3′ rest on the holder 4′. A horizontal arrow 20′ indicates excitation light and an upwards-directed double arrow 21′ indicates emission light.

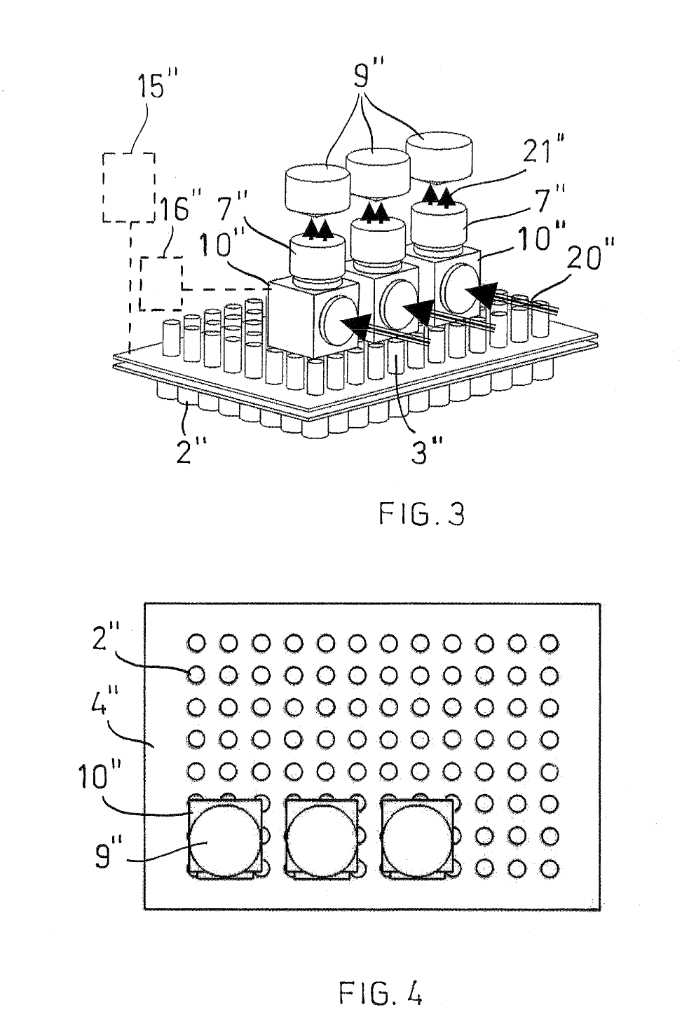

FIG. 3 shows a third embodiment of the arrangement according to the invention. In FIG. 3, the same reference numbers are used as in FIG. 1 for corresponding components. The arrangement of FIG. 3 differs from the embodiment of FIG. 2 in that three lens group/camera combinations 7″, 9″ are arranged to image the samples. Compared with the arrangement of FIG. 2, an about threefold speed is achieved in sample imaging. The arrangement of FIG. 3 is considerably more expensive than the arrangement of FIG. 2, since it comprises two more lens group/camera combinations 7″, 9″.

FIG. 4 is an illustrative top view of the arrangement of FIG. 3. Each lens group is arranged to receive light rays from one objective only. The diameter of the lens group is significantly larger than the diameter of the light beam emitted from the objective, owing to which there is no need to align the lens group on the x-y plane such that its optical axis is exactly in line with the optical axis of the objective, in order for the light beam emitted from the objective to hit the lens group.

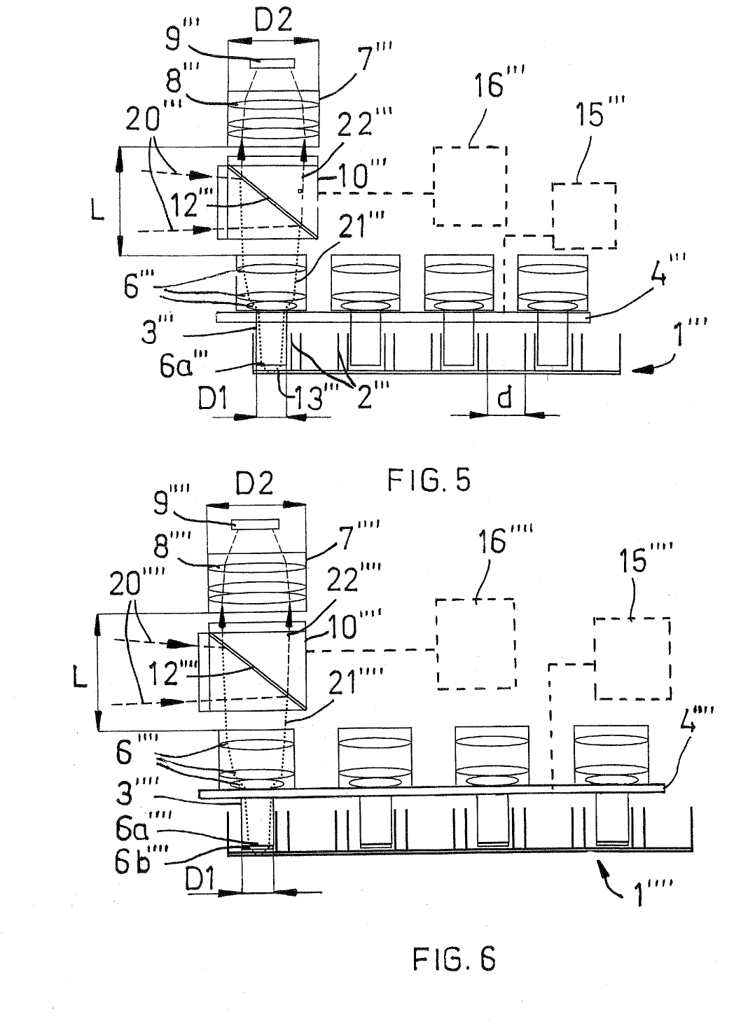

FIG. 5 shows a fourth embodiment of the arrangement according to the invention. In FIG. 5, the same reference numerals are used as in FIG. 1 for corresponding components.

In FIG. 5, the objective 3′″ is composed of usual lenses 6′″ arranged above a well 2′″ and a gradient index lens (GRIN lens) 6a′″ arranged inside the well. A thick broken line 20′″ depicts the passage of excitation light (from left to right). A dotted line 21′″ depicts a common light path of the excitation light and the emission light, and a thin broken line 22′″ depicts the light path of the emission light (from down upwards).

FIG. 6 shows a fifth embodiment of the arrangement according to the invention. In FIG. 6, the same reference numerals are used as in FIG. 1 for corresponding components.

In FIG. 6, the objective 3″ is composed of usual lenses 6″″ arranged above a well 2″″ and a gradient index lens (GRIN lens) 6a″″ arranged inside the well and having a diffractive element 6b″″ arranged on its front surface. The latter is arranged inside the well 2″″. A thick broken line 20″″ depicts the passage of excitation light (from left to right). A dotted line 21″″ depicts a common illuminating train of the excitation light and the emission light, and a thin broken line 22″″ depicts the illuminating train of the emission light (from down upwards).

It is evident to a person skilled in the art that the details of the invention can be implemented in a variety of ways within the scope of the attached claims. Accordingly, it is feasible that the sample plate is displaced relative to the lens group/camera combination in such a manner that the latter remain in place. The size, dimensions and number of wells 2, 2′, 2″, 2′″, 2″″ may vary. It is within the scope of the invention that the same objective may comprise different lenses and other optical elements. The objective placed at least partly inside a well may also be one-piece, i.e. in one part, comprising only one optical element. Any diffractive elements of the objective can be arranged outside and/or inside the well. The diameters of the lens and other optical elements of the objective 3, 3′, 3″, 3′″, 3″″ may vary. Instead of a camera 9, some other image detector may be used. Because the objectives of the arrangement are at least partly inserted in the microtitre well, the structure of the samples can be imaged accurately. In certain situations, accurate imaging of the structure of the samples may not be absolutely important, instead, it may be sufficient to obtain rapidly a lower-quality image of the samples. For the latter imaging, it is feasible that the above-described invention is modified such that the feature according to which the objective should be located at least partly inside well is abandoned. In this case, the lens group and the image detector are placed at a distance and apart from the objectives, which are in their entirety located above the well. The sample plate does not necessarily have to be disposable.

1. An arrangement in an imaging system for samples placed in microtitre wells, the arrangement comprising a sample plate having a plurality of wells for samples, and a lens system arranged in connection with the sample plate and comprising a plurality of objectives being focused to infinity and at least one lens group for forming an image of the samples from light rays representing the samples and passing through the objectives onto an image detector, wherein each objective is arranged to collect the light rays representing a sample at the focal plane of the objective, and said light rays being arranged to pass through said at least one lens group for forming an image of the samples onto the image detector wherein
the objectives are at least partly and detachably arranged inside wells (2, 2′, 2″, 2′″, 2″″) in the sample plate,
the lens group is arranged to receive sample representative light rays from only one well and objective of said plurality of wells and objectives at a time for forming a separate image of the structure of the sample in said one well onto the image detector, and
the lens group and the image detector are constructed as an assembly which is displaceable, by displacement devices, in the vertical and lateral direction relative to said plurality of objectives.

2. An arrangement as claimed in claim 1, wherein the diameter of the lenses in the lens group is larger than the light beam emitted from the objective.

3. An arrangement as claimed in claim 1, wherein the objective comprises at least two optical elements of which at least the first optical element is arranged inside a well in the sample plate.

4. An arrangement as claimed in claim 3, wherein the first optical element is a lens.

5. An arrangement as claimed in claim 4, wherein the diameter of the lens is from 0.5 to 10 mm.

6. An arrangement as claimed in claim 4, wherein the diameter of the lens is from 0.5 to 7 mm.

7. An arrangement as claimed in claim 4, wherein the lens is a gradient index lens.

8. An arrangement as claimed in claim 7, wherein the gradient index lens comprises a surface provided with a diffractive element.

9. An arrangement as claimed in claim 3, wherein the first optical element is a diffractive element.

10. An arrangement as claimed in claim 1, wherein the lens group is arranged at a distance from a single objective of said plurality of objectives, separate from the single objective and on the same side of a well bottom as the single objective, the well bottom belonging to a single well of said plurality of wells.

11. An arrangement as claimed in claim 10, wherein the diameter of the lenses in the lens group is 10-50 mm.

12. An arrangement as claimed in claim 11, wherein the lens group and the image detector are constructed as one unit.

13. An arrangement as claimed in claim 10, comprising a plurality of lens group/image detector units.

14. An arrangement as claimed in claim 12, wherein a filter assembly is arranged between the image detector and the lens group.

15. An arrangement as claimed in claim 14, wherein the filter assembly comprises a beam splitter.

16. An arrangement as claimed in claim 1, wherein the objectives are attached to a common holder.

17. An arrangement as claimed in claim 16, comprising displacement means for displacing the holder in the vertical and lateral directions.

18. An arrangement as claimed in claim 1, wherein the image detector is a camera.

19. An arrangement as claimed in claim 1, wherein the diagonal of the wells is at most 10 mm.

20. An arrangement as claimed in claim 1, wherein the diagonal of the wells is at most 7 mm.

21. A method of imaging samples placed in microtitre wells with an arrangement comprising a sample plate having a plurality of wells for samples, and a lens system arranged in connection with the sample plate and comprising a plurality of objectives being focused to infinity and at least one lens group for forming an image of the samples from light rays representing the samples and passing through the objectives onto an image detector, the method comprising
arranging a plurality of such objectives at least partly and detachably inside wells of the sample plate,
arranging the lens group at a distance from an objective of said plurality of objectives separately from the objective and on the same side of a well bottom as the objective in such a way that the lens group is adapted to receive sample representative light rays from only one well and objective of said plurality of wells and objectives at a time, the well bottom belonging to a well of said plurality of wells,
illuminating the sample in said one well,
collecting light rays representing the sample by means of the objective,
forming a separate image of the structure of the sample from the light rays onto the image detector with the lens group, and
the lens group and the image detector being constructed as a displaceable lens group/image detector assembly, and repeatedly displacing the lens group/image detector assembly relative to a combination of sample plate/objectives for forming separate images of the structures of the samples in the wells.

22. An arrangement as claimed in claim 10, wherein a diagonal of the wells is at most 10 mm.

23. An arrangement as claimed in claim 10, wherein a diagonal of the wells is at most 7 mm.
